(19) United States
(12) Patent Application Publication
(10) Pub. No.: US 2020/0106735 A1
(43) Pub. Date: Apr. 2, 2020

(54) Systems and Methods for Communications & Commerce Between System Users and Non-System Users

(71) Applicants: Salvatore Guerrieri, Garfield, NJ (US); Marshall Taplits, Shenzhen (CN); Alejandro Javier Gramont, Sarosota, FL (US)

(72) Inventors: Salvatore Guerrieri, Garfield, NJ (US); Marshall Taplits, Shenzhen (CN); Alejandro Javier Gramont, Sarosota, FL (US)

(21) Appl. No.: 16/144,590

(22) Filed: Sep. 27, 2018

(51) Int. Cl. H04L 12/58; H04L 29/08

(52) U.S. Cl. CPC H04L 51/36; H04L 67/20; H04L 67/10

(57) ABSTRACT

One aspect of the invention provides for a user application and interface that unifies communication and features to allow users to interact with one another within a single, comprehensive and integrated environment or platform specifically intended to work on mobile devices and desktop computing devices alike, that provides a secure, controllable user interface that may be customized with a suite of holistic productivity. commerce and collaboration applications.

### RELATED APPLICATION

This application claims priority from U.S. provisional application Ser. No.: 62/562,411 filed Sep. 23, 2017, the contents of which are hereby incorporated by reference in its entirety.

### BACKGROUND OF THE INVENTION

Sophisticated computer networks provide modern consumers with a plethora of ways to communicate and interact with each other. For example, consumers can communicate by text message, email, over various voice and or video communication pathways and across numerous hard wired and wireless protocols. Other types of popular communication services include certain public access social networking applications such as Facebook, Google Plus, Pinterest, Twitter that allow users to interact with other people through various posts and messages. Further still, certain specific messaging applications such as Slack and IBM's Sametime allows authorized users to communicate via forms of direct instant messaging to enhance real time collaboration and work place productivity.

However, such conventional communications systems are typically limited in numerous ways. For example, users typically interact within an environment that is either substantially segregated, specialized for a certain function, and/or lacks meaningful customization and productivity options (e.g. Snap Chat). Such platforms do not allow users to seamlessly interact with one another and force users to employ multiple different (and perhaps incompatible) applications to manage their interactions effectively and promote collaboration and achieve improved productivity. Further such platforms are typically designed for commerce (such as eBay) or not well suited for ad/or discourage commerce-based applications and activities (Facebook).

Accordingly, it would be desirable to provide a user application and interface that unifies such features to allow users to interact with one another within a single, comprehensive and integrated environment or platform specifically intended to work on mobile devices and desktop computing devices alike, that provides a secure, controllable user interface that may be customized with a suite of holistic productivity, commerce and collaboration applications.

### SUMMARY OF THE INVENTION

It is therefore an object of the present invention to provide systems and methods for implementing a substantially unified and integrated multi-messaging and communications system.

One aspect of the present invention is concerned with a system and method for providing a substantially unified multifunction messaging service comprising: a user interface operably coupled one or more client electronic devices; a cloud-based server application that pre-processes messages received from the one or more client devices; and a cloud-based communications and control module operably coupled to the server application that includes a plurality of communications applications, wherein one or more of the plurality of communications applications is selected, at least in part, based on input from the user interface and from the server application in order to perform one or more selected messaging functions desired by a system user.

Another aspect of the present invention is concerned with providing a unified application environment for use in both mobile and desktop computing devices, such as smart phones, tablets, smart watches, desktop systems and the like which provide a number of customizable sub-applications of feature sets that integrate and unify certain aspects of user communications, security, productivity and commerce in desirable ways that improve and streamline consumer lifestyle.

Another aspect of the present invention may include a system for communication, purchase of goods and services, and specialized crypto-currency (e.g., NYNJA Token) for use with the system described herein, a multi-currency Smart Wallet, and a virtual marketplace. In certain embodiments, a user interface design is provided that both controls and functions as a system navigation tool and other features described herein.

One significant aspect of the navigation tool of the present invention may be found in the form of digital concentric semi-circles, or ellipses or the like, where categories and subcategories of options are available within a user's thumb or other fingers' reach, for ease of use with mobile devices such as smartphones, smart watches and tablets. A user may use such a command and control interface to select and execute one or more feature options and to access functionality. In some embodiments, the user may switch the position of the command and control interface from right to left hand (or vice versa) on the users' mobile devices to make swiping and selections with his or her dominant hand, through the use of certain customization options.

As described in more detail herein, one or more of the following features may be included within and executed using the command and control module within in the present invention as follows: Create an Account Login and Logout, Profiles, Contacts Emoji, Stickers and Gif Messages, Location Messages and Auto-Adjust, World-Clock Display, member to member call, etc.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 shows an illustrative diagram of a distributed club-based system that may be used to implement aspects of the present invention.

FIG. 2 shows an illustrative user interface in accordance with the principles of the present invention.

FIG. 3 shows a flow chart illustrating some of the steps in accordance with the principles of the present invention.

FIG. 4 shows a flow chart illustrating some of the steps in accordance with the principles of the present invention.

FIG. 5 shows a flow chart illustrating some of the steps in accordance with the principles of the present invention.

### DETAILED DESCRIPTION OF THE PRESENT INVENTION

In the following description of the various embodiments, reference is made to the accompanying drawings, in which are shown by way of illustration, some of the exemplary embodiments that may be practiced. It shall be understood, however, that other embodiments may be used, and various structural and/or functional modifications may be made without departing from the spirit and scope of the present invention.

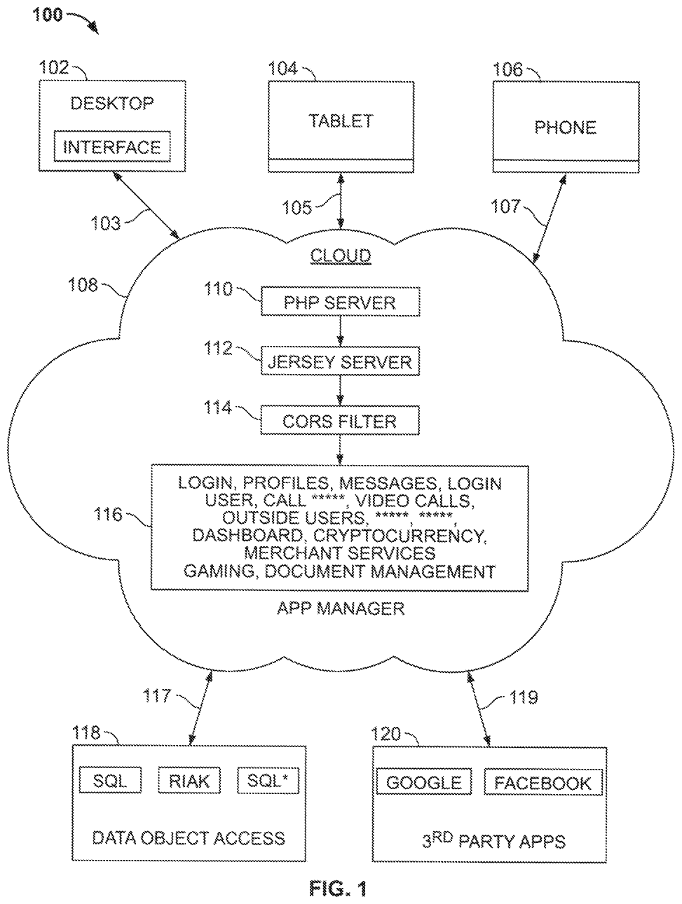

FIG. 1 illustrates one example of a network architecture 100 that may be used to implement one or more of the inventive aspects of the present invention. Various network components such as computer 102, tablet 104, and smartphone 106 may be interconnected via a wide area network (WAN), such as the Internet with certain resources resident as shown in cloud 108. Generally speaking, such components may be any suitable computing and/or data storage device such as a server, personal computer, laptop computer, tablet, mobile phone or the like. Other networks may also or alternatively be used, including private intranets, corporate networks, LANs, wireless networks, and the like and may include secure connections such as VPNs to provide an environment suitable for financial transactions. Encryption techniques such as “block chain,” RSA and the like may also be employed if desired and are useful in connection with the crypto-currency and ecommerce applications further described herein. It will be understood that network 100 is for illustration purposes and may be replaced or modified with fewer or additional computer networks or components. A local area network (LAN) may have one or more of any known LAN arrangements and may use one or more of a variety of different protocols, such as Ethernet, optical, WIFI, etc. Components 102, 104 and 106 and other devices (not shown) may be connected to one or more of the networks via any known suitable wireless connection or hard-wired connection such as coaxial cable, fiber optics, etc. For example, multiple different types of communications links 103, 105 and 107 (as well as links 117 and 119) may be any suitable wired or wireless connections such as Ethernet, Wi-Fi, cellular optical etc.

The term network as used herein generally refers not only to systems in which remote computing and/or storage devices are coupled together via one or more communication paths, but also to stand-alone devices that may be coupled, from time to time, to such systems that have storage and/or computing capability. Consequently, the term “network” includes not only a physical network but also may include a virtual data network which includes the information that resides across virtual and/or physical networks.

As shown in FIG. 1, one embodiment of the invention includes certain functional components may be present and resident in cloud 108. For example, in some embodiments, such components may include one or more of the following: PHP Server 110, Jersey Server 112. CORS filter 114 and application module 116. System 100 may further include access to certain databases in data object access block 118 and which may be any suitable network-based storage device that may be maintained by the service provider or leased for user or application use, etc. Block 120 provides functional access to third party applications, such as Google, Facebook, translation services, commerce links such as eBay, PayPal or Amazon, etc.

In operation, requests such as messages, video or audio calls, database searches, ecommerce interaction etc. all may flow through the integrated suite of products shown in cloud 108. For example, by way of illustration, if tablet 104 sends a message to smart phone 106, the following may occur. First, the message request may be received by PHP server 110 (hypertext preprocessor) which examines header files and essentially parses .php files into simple HTML links that have associated metadata for faster searching and data classification. PHP is optional and may not be present in certain embodiments. Next, such request may be prosed by a Jersey Server 112 to expose and connect certain API dependencies. These modules are optional and may depend on development application used on the client devices.

Next, the outgoing data may be passed through CORS filter 114 which may be any suitable generic solution for fitting Cross-Origin Resource Sharing (CORS) support to Java web applications. CORS is currently a W3C standard for enabling cross-domain requests (transcription) from web browsers to servers and web APIs that opt in to handle them.

Next, the preprocessed request may now be transmitted to the application manager module 116 of the current invention. At this point, the requested application request may appropriately process depending on the feature(s) in use or requested. For example, all call features such a port to phone, world clock, group messaging, location-based services, user interface metadata such as notes or vote, the security level of the communication, confidential and obfuscated messaging, translation requests, gaming, ecommerce and crypto-currency services etc., may be provided by one or more applications resent in management module 116. Such features are described in more detail herein.

After such processing, the message may transmit to phone 106 across link 107 along with all relevant application environment and management information from cloud 108 and may further include any information from databases 118 and any third-party application information obtained from block 120 in response to the pending request. Information from blocks 118 and 120 may be may be obtained and embedded within the message sent to phone 106 by the application manager module 116 or other components within cloud 118. Such processing includes processing from block 110, 112 and 114.

In certain embodiments of the inventions, servers and various application programs may be combined on the same physical machines, and retain separate virtual or logical addresses, or may reside on separate physical machines. It will be understood that FIG. 1 merely illustrates just one example of a network architecture that may be used, and those of skill in the art will appreciate that the specific network architecture and data processing devices used may vary, and are secondary to the functionality that they provide, as further described herein. For example, services provided by cloud 108 may be partially or fully resident on their respective client devices. Moreover, application programs in management module 116 may be distributed across multiple remote computing platforms and/or may be combined on a single server or other suitable computing device whether distributed or local, etc. and thereby control overall operation and the distributed applications originating therefrom.

Those of skill in the art will appreciate that the functionality of data processing devices as described herein may be spread across multiple data processing devices, for example, to distribute processing load across multiple computers, to segregate transactions based on geographic location, user access level, quality of service (QoS), etc. In addition, certain secure or anonymous interactions or transaction such as those involving crypto currency, payment or other sensitive data may be connected, via direct connection or secure or indirect connection, or via some other network which may be a secure or private connection such as a VPN and/or protected through certain encryption techniques such as block chain.

Furthermore, one or more aspects of the invention may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) HTML or XML. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein (discussed in more detail below).

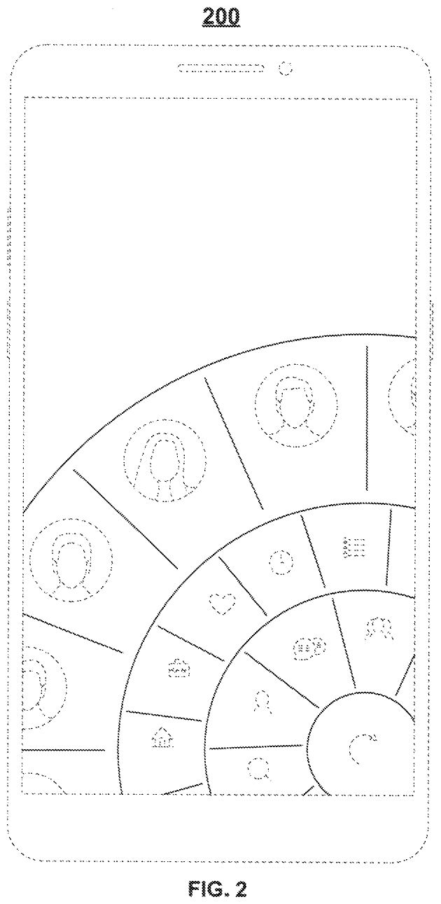

FIG. 2 is an embodiment of a exemplary user interface 200 constructed in accordance with the principles of the present invention.

As mentioned above, application management module 116 may have numerous specific applications that substantially control and manage the user or member interactions. These functions may originate from a client device or cloud 118 or may be fully remotely resident. The following discussion explains the various implementation scenarios and functions possible with embodiments of the present invention. These functional modules and/or applications are typically part of or managed by management module 116 and are described below.

### Create an Account Application

Users may be able to create an account using conventional methods. For example, a phone number or any other form of two factor authentication protocol known in the art which may include the use of PINs and/or biometrics. In one typical embodiment, the user's phone or tablet will receive a call, an SMS message, or email for verification purposes and the user may enter the received information in that message to activate the suite of applications described herein or a specific singular application from the suite (e.g., such as a crypto-currency application). Moreover, once an account is established, a login program may be transmitted from manager 116 to and installed on the user's device to allow future login and logout operations (accessible through bookmark or icon).

### Profiles and Contacts Application

Upon registration, users may be prompted to enter certain profile information for each account they use. This may include personal demographic information and other information the account holder desires to share with others. Such information may include phone number, address, current geographic location, whether or not they are currently online or not, etc. In some embodiments, users may have multiple profiles and avatars. Such profiles may be correlated such that viewers know whether multiple accounts are held by the same user (or not). This may be desirable in certain applications such as gaming.

The present invention further contemplates a contact list for system members. Users may be able to add contacts via their contacts list using any conventional method known in the art which may include entering a phone number manually and/or via a barcode scan such as a QR code scan. QR codes may be personalized in certain predefined formats. Contacts may be displayed to a user by text, QR Code, or both. Additionally, users may integrate their phone contacts, giving them the ability to click into a member chat room with any of their contacts.

Moreover, the first time one system user contacts or interacts with another, both contacts lists may be updated with other's contact information and vice versa, thereby minimizing the number of manually entered contacts. It will be understood that the system of the present invention is contemplated to allows for the transmission to other members of a wide and rich variety of multimedia message types including or containing text, attachment files such as Word or Excel, audio, photos, videos, contacts, graphics, GIFs, emoji characters, stickers, augmented reality and the like. The aforementioned media can be original work from or created by users.

The contact information and/or profiles may be stored on a client device, in cloud 108 as metadata and/or in databases 118.

### Location Message Application

In certain embodiments, system users may be able to optionally send messages to other system users which include their current geographic location (within a desired degree of precision). This feature may be setup at the time certain applications are installed or may be an option that the user selects via user interface 200 on a case by case basis. Such information can be shared selectively with certain recipients and not with others based on user preference which may included predefined criteria. Furthermore, other system applications may become active in the case where a certain user comes within a certain (predefined) distance of another user (substantially automatically). For example, when a user on a contact list comes with 200 meters of another system user both user may be notified automatically and inquire if they want to engage each other. Such a “live location” mode may be useful when users are looking to meet each other. This application may be resident on a client device or in cloud 118 (or a combination of both).

### Time Zone Awareness and World-Clock Display Application

Users may be able to activate a world clock to show the local time of other users currently on the system or by accessing certain contact or profile information. For example, when user adds another user to a chat, or participates in messaging application, the world clock display may reflect which time zone that user is in (e.g., by color code avatar etc.). When other users are present on a chat screen, calling screen, or any other contact, the time difference in terms of +/− hours may be displayed or the local time of the user (e.g., using 24 hour convention). This may be displayed in the abovementioned messaging screens in a conspicuous and notable fashion such that others user immediately aware. This application may be resident on a client device or in cloud 118 (or a combination of both).

### Member Calls and Conference Calls

Users of present invention may initiate telephone calls to each other over the Internet, using, for example, known VoIP technologies resident in management module 118 and/or client certain devices. For example, a user may choose to call another user where the call mode is over an application-controlled network or transmission path. In many embodiments, users may choose a voice call or video call option and may have access to well known call features such as mute, volume, speakerphone, etc.

Users within a predefined group may have a group call/conference call over the Internet using the system an methods described above. For example, within a predefined group, one of the users chooses to start a call with more than one additional user through a user interface such as call screen or selecting a contact from the list of contacts. The call is then placed over the application network (audio and/or video). Additional users may be conferenced in to the current call by simply selecting other users to join through the user interface. If any of the users hang up or are disconnected, and they need to get back into the call, they can enter the call again by simply clicking “join active call” button on call screen user interface. This feature allows the user to bypass re-entering a dial-in number and participant pin. This application may be resident on a client device or in cloud 118 (or a combination of both).

### Port Out to Phone

Each system user may keep a list of their own various phone numbers—such as their home, mobile, landline, numbers assigned to local SIM cards in other countries, etc. A user may have multiple phone numbers on file within the system of the present invention. When an incoming call comes via an application-controlled network, for example a VoIP network, the recipient user may choose to “port out” (i.e., transfer) that call to one of the recipient's other associated telephone numbers rather than answering the call over the Internet.

This feature may be particularly useful and/or desirable when the recipient does not (at that time) have a good WiFi or 4G connection, but still desires to take the call. This feature provides flexibility for the user receiving a call while providing the user making the call with the confidence to place the call using the NYNJA system.

Such “porting” technology and its associated functionality are believed to be new and different from how other prior art calling applications work. Typically, other call applications let a user either call Internet to Internet (VoIP), or call internet to wired/wireless. Prior art calling applications do not enable the receiving party to choose how (which communications path) to receive the call, regardless of how the caller made the call.

In some embodiments, the QoS of the various available communication paths may be analyzed such that most currently “robust” path may be automatically selected to ensure the highest call quality available for system users. This may fundamentally change the nature of calling because the person initiating the call no longer needs to think about where the receiving party will be e.g., at home, in the car, online or offline etc. The initiating caller knows to “just call on the member-based application system” and the receiving party may answer the call if they are available wherever their location is and how good their network connection is.

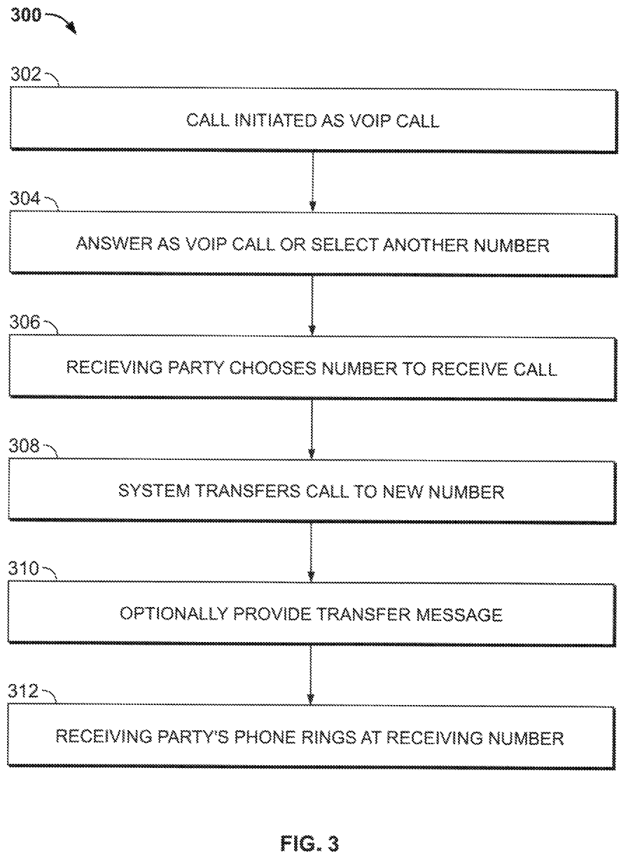

Some of the steps involved in the porting technology described above are shown in the flow chart of FIG. 3. First, at step 302, a telephone call may be initiated as a VoIP call. Next at step 304, the receiving party has the option of answering the call as a VOIP call. However, receiver also has the option of choosing the “Port Out” feature at step 304, which may then present the receiving party with a list of their other phone numbers to choose from. At step 306, the receiving party chooses one of those phone numbers, where and/or or how they want to receive the call. At step 308, the call may then be transferred in real time to the new selected phone number.

In some embodiments, while the call is being transferred from one number to another, the initiating caller may optionally see a message to inform the initiator what is going on such as “please wait . . . #username# has requested transfer of this call to a different phone line” (step 310). Next, the receiving party's phone rings at the selected number and may be answered on the new line (step 312). The result of these steps is that the initiating caller is still on their original Internet call, whereas the receiving party is now on the call where the system ported the call to and yet both calls are connected so the users can carry on their conversation. It will be understood from the foregoing that the above is just one illustrative embodiment and there are other embodiments and permutations of the above-identified example whereby either party can transfer numbers during a call (receiving and/or initiating). This application may be resident on a client device or in cloud 118 (or a combination of both).

### Real-time Multi-Media Messages

In operation, a user of the disclosed system may include attachments to send to message recipients during an active communication or chat session in substantially real-time. For example, a user may be video chatting with another system user and either can choose to send (from storage or elsewhere) one or more videos, pictures or other graphics and/or audio attachments such as music of voice messages from others. Moreover, users may engage in group video calls. This process may begin by a user within a predetermined group starting a video call from a user interface and have the ability to reconnect into the ongoing call, as well as the ability to switch to/from voice from video (others can remain on video). This application may be resident on a client device or in cloud 118 (or a combination of both) and may receive hosted content from databases 118- and otter herd-party applications 120.

### Lists and Action Items

As mentioned above, one of the objects of the present invention is to improve user productivity and to provide an integrated and streamlined communication platform. One way this may be accomplished is by providing a messaging application that allows a user to take notes and organize task list within the construct of the messaging environment.

For example, during a chat or group chat, one or more tasks or “to do” reminders may be presented to the user(s) through user interface. In some embodiments, users may be able to flag messages and assign them to lists, along with comments. For example, a user can assign a task contained in a message as a “to do,” item and further include other information or criteria such as assign a due date or a reminder time and add comments.

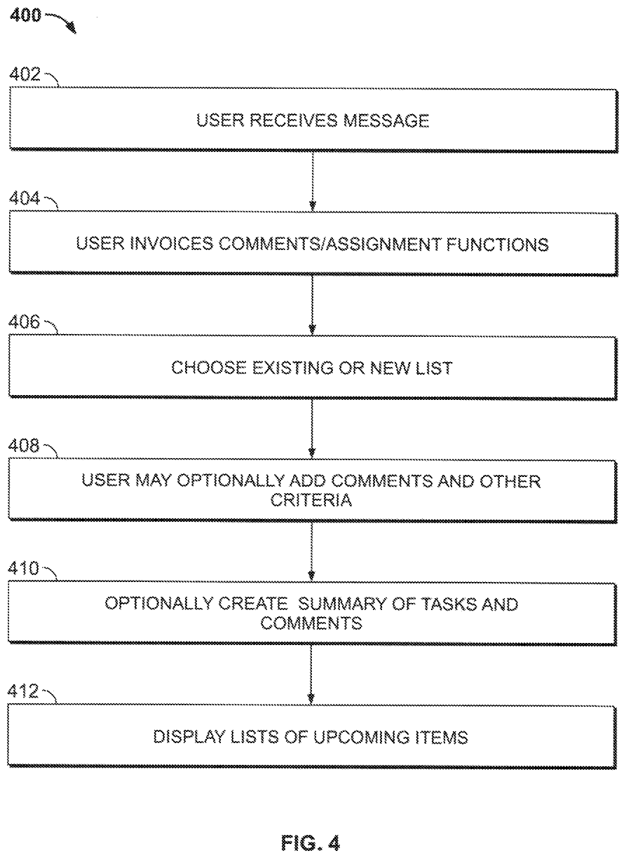

An illustrative workflow embodiment of this feature may include the following steps in flowchart 400 of FIG. 4. First, a user receives a message at step 402. Next, the user may invoke a comment or assignment function through interface 202 at step 404. One way this may be accomplished for example is by a user “holding down the message” to invoke a pull down menu and then and selects the “Add to list” feature. At step 406 a user can choose an existing list or add a new list. At step 408, a user may optionally add comments about the item/message they are adding to the list and assign a due date or reminder time. At the conclusion of the session a summary of the assigned tasks and comments may be sent to each participant (step 410). On a going forward basis, each user can select and view the lists/comments and upcoming to do items in an easy to read display (step 412) which may in some embodiments be provide substantially automatically in “reminder” fashion.

This application may be resident on a client device or in cloud 118 (or a combination of both) and may receive hosted content from databases 118- and third-party applications 120.

Communicating with Out of Application Parties

In the case where a user of the current system desires to communicate with a party who is not yet a user (or member) of the system (an “out of network” party) the system may generate a web link or other referential marker to invite a non-member to share specific chat (or group chat) with the non-member one case by case basis. In some embodiments, a new invitation may be required each time a non-member is to participate in additional chats. In other embodiments, links may be used substantially indefinitely or for a preset number of logins.

With is approach, and without having the need to create an account or other action, a system user can send an invite to, and communicate with, the non-member. This may be accomplished using the following steps. First, a member may prompt the system to generate a link through a user interface to share chats or group chats with a non-user. Next, that link may be sent via a conventional messaging system (e.g., SMS or email). After receipt, the non-member opens the link in any web browser or any member based application program which grants access to member chat room. At this point, the user and non-user can text, send images etc. on the member system.

Another feature of the present invention allows a user to generate a direct link to any image, video or file from within a chat to be able to share offline (by email, etc.). When the receiving user selects the link, they will be able to download the file directly, even if they are not a system user or member. Any party has the link may have direct access to download the file. In some embodiments, the link may be password protected.

For an important or critical message, another feature of the present invention may allow a user to select Priority Chat. This feature may operate similarly to the way in which an email read receipt works—a user can request explicit acceptance message confirming receipt of a chat message. This is useful not only for individual chats but also for group chats and also in instances where one or more members are broadcasting information to many recipients (members and/or non-members) and prefer or require confirmation of which parties explicitly received (and read) the transmitted message. Thus, in operation, a user may send a message and designate it as read receipt requested. Next the receiver observes the message and is prompted to confirm he/she read the message. After conformation, the system sends a notification that the message was received and read.

Furthermore, users of the present messaging a communications system may have access to connect their account to commonly used third party platforms such as those by companies like Google, Slack and IFTT through block 120 to create integrations to make their experience and use more productive. Application integrators may charge fees to users for the use of such integrations as well as may facilitate a marketplace for 3rd part sellers to build and monetize their integrations. The present invention may extend this marketplace to include individual applications which can leverage the communications and payment capabilities and a virtual app store within the system may emerge. These applications may be resident on a client device or in cloud 118 (or a combination of both)

Secure and Stealth Chat with Automatic Deletion

Due to privacy concerns, another feature of the present invention may allow a user the ability to hide certain designated chats or contacts entirely, and be able to return or re-access that information only after entering a security code or chat-based PIN. This is similar in function to a web browser's incognito mode where there is no trace of the information for example in system cache. Accordingly, a user selected a chat though user interface XXX (e.g., press and hold) a chat or contact and chooses “incognito mode” from a pull down menu or list of options. Afterwards, incoming messages from that user do not cause notifications so that the privacy remains intact. In some embodiments, discrete graphic. tactile or audio output may alert the user of presence of a new private message. At that point, to return to the hidden contact or chat, the user enters a password, which may include biometrics which then reveal the hidden chat or contact.

Another feature of the present invention may allow a user to choose to share a private message one on one with the recipient where that message is not permanently stored on a server or client device and may auto-delete itself after a user selected or system predetermined time interval (such as 1 hour, substantially instantly, etc.). For example. in operation a user may desire to send a stealth message. After composing and the message, the user may select the auto delete time-period and presses send. The receiver can see the message, but only for the selected time interval and only on a certain selected or approved user's (mobile) device (e.g., not on all their devices such as a laptop application). For security reasons, after the auto deletion is set, a user may not take a screen shot of the message print it or otherwise maintain a system record of the message.

In some embodiments, a user may choose to send a private message and designate that message “NSFW” (not safe for work). In this case, the message may be delivered in a grayed-out or other obfuscated manner such that it is unreadable. To read the message or see the attachments (image), the receiving user may first activate the message (e.g., swipe their finger over the message), then unlock the message by entering a code, or entering biometric data such as a fingerprint, retinal scan, facial scan or the like, which reveals the message(s) for a period of time before returning to grayed out mode (upon which an additional activation routine must be performed as described above to re-activate the message).

This application may be resident on a client device or in cloud 118 (or a combination of both) and may receive hosted content from databases 118- and third-party applications 120.

### Message Translation (Live Human)

Another aspect of the present invention may include the ability during a conversation to receive a message in another language or to send a message in a language which is not native to the user. Machine translation is already found in some applications, such as through the use of Google translate where the user can select and copy a message and request immediate machine-based translations.

However, such machine translations may be inaccurate. To reduce the chance of such errors, the present invention provides the ability for live human translation essentially “on-demand.”. Thus, in operation, a user may type a message to send or receives a message in a language that is not native to them. Next, the user selects the message and chooses “Human Translation” option from a pull-down menu in user interface 202. The user then chooses the target language to translate to and the revives a message regarding approximate cost of such translation. Once the terms are accepted by the requester, the selected message may then be sent to an organic or third-party virtual marketplace and the translated by a live human “on-demand.” The translated message may then be provided back to the user who requested it. This same system may be used to translate text messages to voice messages in another language and vice versa, if desired. Moreover, such messages may be audio messages that are transcribed to text using known voice capture technology and them may be translated (by a live human or machine bases translation) and provided as text or voice messages back to one or more users or intended message recipients.

This application may be resident on a client device or in cloud 118 (or a combination of both) and may receive hosted content from databases 118-and third-party applications 120 which may include translation services.

### Conditional Notifications

Another feature of the present invention may allow a user to select “conditional notifications” which permits the user to more accurately control when they want to be notified and from whom they may want to receive notifications from. Such a feature is both desirable and useful for users who belong to many groups. For example, assume a user joins a chat or message sharing group. That user may desire to “mute” (not receive) certain aspects of those notification (or simply not played on his or her screen or speaker). For example, a user can mute completely, for a specific period of time, mute selected parties by user designation, by certain keyword, and by message activity level, etc. With complete mute selected, the user receives substantially no notifications from the group. If a certain period of time is desired, the user may be prompted to enter the time they want to be on mute, for example from 7 pm to 7 am (after work) or an on demand by the user.

Furthermore, a user can choose specific users in the group that are exempted from mute. For example, the user wants to be on mute unless a certain person speaks (group leader), which deliver messages from those parties. The user can choose one or more “key” words which may trigger or otherwise activate a notification. For example, if the word “invoice” or “payment due” are said in the group the user gets notified, even though they are generally on mute. In the case of a message activity level-based notification, the user can specify an activity level such as “at least 10 messages in 2 minutes”. This enables the user to stay on mute in a group which is generally low volume, however if the volume picks up in chatter within the group beyond a set threshold, the user is notified.

While chatting with someone (or even with your own account), it may be common to need to act on a message. For example, if a user sends a message requesting a specific action at a specific time (e.g., pick up the kids at school at 3 PM tomorrow) the recipient needs to remember to do that. Historically, a user would need to add this to his or her calendar manually. However, the present invention may include the ability to select the message and schedule it for later arrival (retransmission), such as tomorrow at 3 pm. At the specified time that same exact message will automatically be sent to me again at 3 pm, in effect acting as a mini-calendar or reminder service right within NYNJA system. No known applications have such integrated messaging with calendar/reminder features using the actual messages and assigning a scheduling element to them.

Similarly, a user may an receive an email or SMS message (such as a flight confirmation) which needs to be accessed later (such as an hour before checking in). In accordance with an aspect of the present invention, A user shall be able to email or text themselves on the current system or set up other aliases such as “me@nynja.biz” or alias SMS destination. When the email is received to these addresses, the contents of the email (along with any attachments) may be sent as a message to their alias user account. Once received, the user can then schedule the message to arrive again later (as described above). No applications offer an email to messenger function. Thus, in operation, a user may set up one or more alias addresses such as an email addresses that they can send from, so that it is known by that user when an email is received and from which email address. When the alias receives an email, the system checks which user it's from and which messenger account it needs to go to and may forward the email contents with attachments as a message to the designated recipient.

This application may be resident on a client device or in cloud 118 (or a combination of both) and may receive hosted content from databases 118 and 3^{rd} party applications 120. and third-party applications 120 which may include certain alias or message forwarding solutions.

### Decision Quorum Messages

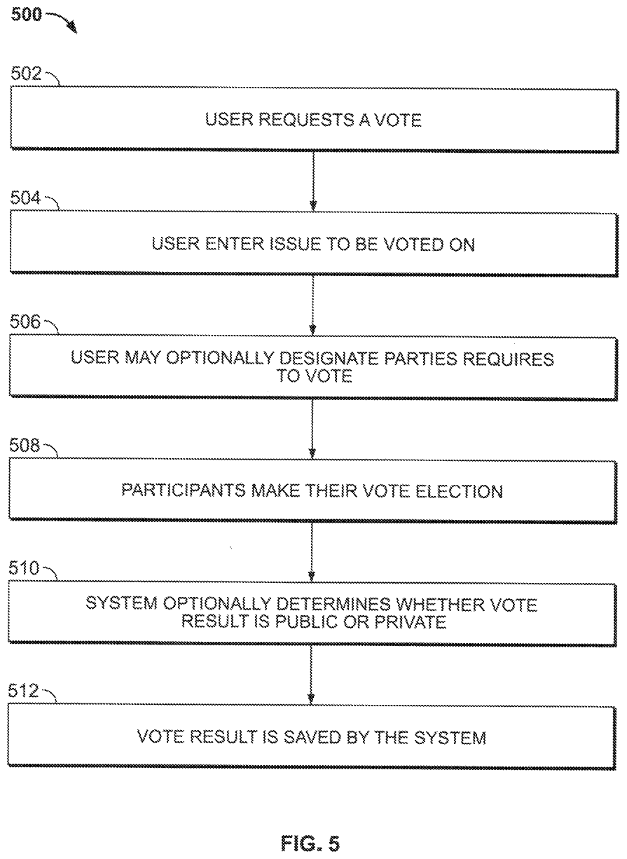

Improving group productivity during conferences or chats is a goal of the present invention. With respect to certain business applications, such as a group chat or conference (such as a virtual board meeting) it may become important to take votes and pass motions and memorialize and record the results of such meeting and vote outcomes. The system of the present invention may enable a new content or metadata type called “vote” where a user proposes a motion and participants on the call or group can vote (e.g., yes, no or abstain). The vote result then becomes a part of the history of the group to be referenced in the future (e.g., stored in databases 118). In some embodiments, this feature may operate as described in flow chart 500 of FIG. 5.

First, a user may invoke a vote session selecting such a feature from a pull-down menu on the messaging interface screen. This informs other participants a vote is requested (step 502). A user may then make a motion by typing in specific a question (step 504). The user requesting the vote may optionally select the participants in the group who needs to vote or can select “all” by default (step 506). Next, each user is notified that they need to vote and allows each user to vote by selecting their desired response from a menu (e.g., yes/no/abstain) at step 508. In some embodiments, each user vote selection may be “public,” in which case participants can see how each user responded or can be kept secret depending on the setting selected by the Group Administrator or the user that requested the vote (step 510). Upon completion, vote result may stored in database 118 or elsewhere as part of the history of the group as a message or other data structure (step 512).

This application may be resident on a client device or in cloud 118 (or a combination of both) and may receive hosted content from databases 118.

### Commerce Applications—My Tab

Another productivity feature associated with the present invention is the ability to keep track of expenses and financial transaction within or among various messaging interactions. For example, the “My tab” option shown in user interface within a chat allows users to keep track of money owed to each other or owed to a group. In some embodiments, this may simply be on a “user to user” basis or within the various users of a group. For example, if a group of members travel together, they may need to track expenses. This function does not specifically focus on the actual payment of the expenses (which is possible as described below), but rather merely operates a tab calculator and register. For example, within a chat or group, user can choose to “start new tab.” The chat may have one or more active tabs and each tab may have one or more expenses associated or assigned to it whether automatically or manually by a user. Each such tab may have different percentage splits among the group members. Each tab can be marked as paid or with a payment due date. Payment is handled (and scheduled) either outside the application with a third-party service such as PayPal or with for example a new form of crypto payment described further herein. This system may include the use of an embedded multi-currency wallet that holds Bitcoin, Ethereum, NYN and other ERC20 compatible tokens Users may be able to send crypto-currency via chat within NYNJA itself or to external wallets. Users may be able to import from and export to other wallets.

### Dashboard

As shown in user interface 220, another feature of the present invention may include a Dashboard for your own account including sending files/messages to yourself, ability to click into your chats, groups and channels, see your contact requests, see your scheduled and starred messages, manage your favorite locations, manage your own phone numbers for port out.

### Professional Photo Filters

Currently it is popular to have comical or whimsical photo filters that create imaginary faces such animal faces, etc. Another feature of the present invention may allow a user to apply such professional whimsical photo filters for business and pleasure. For example, a user may take a normal photo needs a photo of himself/herself in a suit (Augmented Reality or AR). The user may superimpose the user's picture into a picture of the individual in the real photo into the suit.

Market and Ecommerce using a Crypto-Currency

One goal of the present invention is to create a virtual marketplace within the application where any user may request goods and/or services and any other users may fulfill such goods and/or services and this transaction may be made contemporaneously in a peer to peer fashion. Accordingly, crypto-currency may be created (e.g., an “NYN” token) and token may be released, which, in some embodiments may be an ERC20 compliant token on the Ethereum blockchain to facilitate substantially all payments to and from system users. Thus, in operation, a user may purchase such tokens either within the application as an in-application purchase or via an exchange. Next, a user may action any message for work, such as translation, logo design, photo editing, research, etc. the goods and/or services are virtually unlimited, and a guideline can be seen on sites like Fiverr, Upwork, etc. When a service is required, the request goes out to the network and users can accept the job (like Uber, whoever is first to accept wins the service request).

This may be accomplished by an in-network auto-assign engine that enables users to access the entire cloud labor pool to guarantee the best match for the requested job. After the requested work is successfully completed and delivered back to the requesting user and upon acceptance, the payment can be made with a token. In some embodiments, the system host may take a commission or commerce and payments in consideration for providing the network services. In case a dispute arises between the user and the service provider, the present invention provides a smart contract-based arbitration resolution mechanism will be used to intelligently solve the dispute. Users and service providers reputation will be kept in the blockchain. Users who have earned tokens can “cash out” by transferring their coin to Ethereum on any exchange and from Ethereum into cash on exchanges or at banks.

Aspects of the present invention may further include merchant services. Member or system based financial services may include online in-network (or third party) ordering of goods and service with payment using a crypto-currency tokens described herein or point of sales systems as are known in the art. Such systems may be linked to or include to a resident calculator to obtain the most accurate financial exchange data.

### Gaming

The present invention may further include an in-application configurable Fidget spinner. For example, the fidget spinner may have configurable colors, styles, shapes and the like. The Fidget spinner may be digitally spun for including but not limited to spin for entertainment yourself, spin to get a fortune, press fortune it flips over and see/get 6 lucky numbers. Send those numbers to friends, family business associates. Winners of various game of chance sponsored in network such as a lottery can get credits, token and prizes, etc.

### Graphical Representation of Contact Associations

The present invention may further include a graphical representation of how contacts may be associated with each other.

User 1

[symbol]

### User 2, etc.

[symbol] New Contact, etc. New Contact, etc.

It will be understood that these steps are merely illustrative and are not meant to be comprehensive or necessarily performed in the order shown. Persons skilled in the art will appreciate that the present invention can be practiced by other than the described embodiments, which are presented for purposes of illustration rather than of limitation, and the present invention is limited only by the claims which follow.

What is claimed is:

1. A system for providing a substantially unified multifunction messaging service comprising:
a circular user interface operably coupled one or more client electronic devices;
a cloud-based server application that pre-processes messages received from the one or more client devices; and
a cloud-based communications and control module operably coupled to the server application that includes a plurality of communications applications, wherein one or more of the plurality of communications applications is selected, at least in part, based on input form the user interface and from the sever application in order to perform one or more selected messaging functions desired by a system user.

2. The system of claim 1, wherein the user interface is installed on the one or more client devices.

3. The system of claim 1, wherein the cloud-based server application determines functional request dependencies from communication requests input by a user in the user interface when selecting messaging functions.

4. The system of claim 1, wherein the cloud-based communications and control module manages calls or messages between client devices.

5. The system of claim 1, wherein the managing comprises allowing a call recipient to change the transmission routing of an incoming call or message.

6. The system of claim 5, wherein the changing of the transmission routing includes changing from a cellular communication link to an Internet communication link.

7. The system of claim 5, wherein the cloud-based communications and control module includes a translation application.

8. The system of claim 5, wherein the cloud-based communications and control module includes one or more commerce-based applications.

9. The system of claim 5, wherein the cloud-based communications and control module includes one or crypto currency-based applications.

10. The system of claim 5, wherein the cloud-based communications and control module includes one or more gaming applications.

11. The system of claim 5, wherein the cloud-based communications and control module includes one or more document management applications.

12. The system of claim 5, wherein the cloud-based communications and control module includes one or more document management applications.

13. The system of claim 5, wherein the cloud-based communications and control module includes one or more integrated dashboard applications.

14. The system of claim 5, wherein the cloud-based communications and control module includes further manages video calls and multimedia messages.

15. A method for providing a substantially unified multifunction messaging service comprising:
providing a user interface operably coupled one or more client electronic devices;
providing a cloud-based server application that pre-processes messages received from the one or more client devices; and
providing a cloud-based communications and control module operably coupled to the server application that includes a plurality of communications applications, wherein one or more of the plurality of communications applications is selected, at least in part, based on input form the user interface and from the server application in order to perform one or more selected messaging functions desired by a system user.

16. The method of claim 15, further comprising the step of the cloud-based server application determining functional dependencies from communication requests input by a user in the user interface when selecting messaging functions.

17. The method of claim 15, further comprising the step of managing calls or messages between client devices with the cloud-based communications and control module

18. The method of claim 17, further comprising the step of allowing a call recipient to change the transmission routing of an incoming call or message.

19. The method of claim 18, further comprising the step of changing from a cellular communication link to an Internet communication link
